(19) United States
(12) Patent Application Publication
(10) Pub. No.: US 2010/0011170 A1
(43) Pub. Date: Jan. 14, 2010

(54) CACHE MEMORY DEVICE

(75) Inventors: Tohru MURAYAMA, Kanagawa (JP); Hideyuki Miwa, Kanagawa (JP)

Correspondence Address: YOUNG & THOMPSON, 209 Madison Street, Suite 500, Alexandria, VA, 22314, US

(73) Assignee: NEC Electronics Corporation, Kanagawa (JP)

(21) Appl. No.: 12/493,636

(22) Filed: Jun. 29, 2009

(30) Foreign Application Priority Data
Jul. 9, 2008 (JP) 2008-178644

(51) Int. Cl. G06F 12/08; G06F 12/00

(52) U.S. Cl. 711/137; 711/213; 711/E12.001; 711/E12.057

(57) ABSTRACT

A cache memory device includes an address generation unit, a data memory, a tag memory, and a hit judging unit. The address generation unit generates a prefetch index address included in a prefetch address based on an input address supplied from a higher-level device. The tag memory stores a plurality of tag addresses corresponding to a plurality of line data stored in the data memory. Further, the tag memory comprises a memory component that is configured to receive the prefetch index address and an input index address included in the input address in parallel and to output a first tag address in accordance with the input index address and a second tag address in accordance with the prefetch index address in parallel. The hit judging unit performs cache hit judgment of the input address and the prefetch address based on the first tag address and the second tag address.

### BACKGROUND

1. Field of the Invention

The present invention relates to a cache memory device having a prefetch function.

2. Description of Related Art

A cache memory is disposed between a higher-level device and a lower-level memory. When a memory access is attempted from the higher-level device, the cache memory judges whether data specified by a memory address to which the higher-level device accesses (hereinafter referred to as “input address”) is cached in a data memory included therein. In the case of a cache hit, which means when the data specified by the input address is cached, the cache memory supplies the data read out from the data memory of its own to the higher-level device. On the other hand, in the case of a cache miss, which means when the data specified by the input address is not cached, the cache memory reads out the data from the lower-level memory to perform refill of the data memory and supplies the data read out from the lower-level memory to the higher-level device.

The higher-level device that performs an access request to the cache memory is an RISC (Reduced Instruction Set Computer) type processor, a CISC (Complex Instruction Set Computer) type processor, a DSP (Digital Signal Processor) or the like. Further, when the cache memory is used as a lower-level cache of another cache memory (second cache or third cache, for example), the higher-level device of the cache memory is a higher-level cache. Further, the cache memory may be embedded in an MPU (Micro Processing Unit) including a processor which is the higher-level device or may be externally attached to the MPU.

Now, the basic configuration and the operation of the cache memory will be described for the purpose of making clear the definition of the terms used in this specification. FIG. 6 is a block diagram showing main units of a four-way set-associative cache memory.

A data memory 80 included in a cache memory 8 is a memory to store data corresponding to a subset of data stored in a low-speed memory (not shown). A storage area of the data memory 80 is physically or logically divided into four ways. Further, each way is managed by a data storing unit of a plurality of words called “line”. Hereinafter, the data stored in one line of the data memory 80 is called “line data”.

A data storing area of the data memory 80 is specified by decoding an input address supplied from a higher-level device (not shown). More specifically, the line is specified by an “index address” which is a middle part of the input address. Further, in dealing with the data access in a word unit, a word position in the line is specified by decoding a “word address” which is a lowest part of the input address. A highest part of the input address is a “tag address”. In the following description, the word address, the index address, and the tag address included in the input address are called “input word address”, “input index address”, and “input tag address”, respectively. The number of bits of each of the input word address, the input index address, and the input tag address are determined according to the way of designing of the number of words included in one line, the number of lines included in one way, and the number of ways of the cache memory 8.

A tag memory 81 is a memory that stores the tag address in accordance with the line data stored in the data memory 80. The tag memory 81 is accessed by the input index address, and outputs the tag address specified by decoding the input index address. As the cache memory 8 in FIG. 6 is four-way type, the tag memory 81 outputs four tag addresses for one input index address. Further, the tag memory 81 may hold a valid flag (not shown) indicating the validity of the tag address that is stored, or a dirty flag (not shown) indicating the occurrence of the mismatch between the data held in the data memory 80 and the data held in the lower-level memory as the data memory 80 is updated by the store access, for example.

An address register 82 is a register that holds an input address supplied from the higher-level device for the memory access.

A hit judging unit 83 performs cache hit judgment of the input address by comparing the input tag address with the four tag addresses output from the tag memory 81. More specifically, when the input tag address and one of the outputs of the tag memory 81 match with each other, the hit judging unit 83 outputs a signal that indicates a cache hit. On the other hand, when they do not match, the hit judging unit 83 outputs a signal that indicates a cache miss. The output signal of the hit judging unit 83 is, for example, a signal of four bits in total that indicates the hit judging result for each one way by a logic value of one bit.

A selector 84 selects one output that corresponds to the input tag address from among the four line data output from the data memory 80 in accordance with the access by the input index address in the case of a cache hit. The output of the selector 84 is supplied to the higher-level device as a read data.

When it is judged as the cache miss by the hit judging unit 83, the controller 85 controls rewriting of the tag memory 81 by the input tag address and refill of the data memory 80. The control of the refill includes control of data reading from the lower-level memory (not shown) and rewriting of the data memory 80 by the data read out from the lower-level memory. Further, the controller 85 outputs a wait signal for notifying the higher-level device (not shown) of the occurrence of the cache miss.

A cache memory having a prefetch function in addition to the basic function of the above-described cache memory is known (see for example, Japanese Unexamined Patent Application Publications Nos. 2001-344152 and 08-314803). The tag memory included in the cache memory disclosed in Japanese Unexamined Patent Application Publication No. 2001-344152 concurrently outputs two tag addresses of a tag address of the line specified by the input index address (n-th line, for example) and a tag address of the next line (n+1 th line, for example) when one input index address is input. Further, the cache memory has a second hit judging unit that compares the tag address of the n+1 th line with the input tag address in addition to a first hit judging unit (corresponding to the hit judging unit 83 stated above) for comparing the tag address of the n-th line with the input tag address. According to this configuration, the cache memory disclosed in Japanese Unexamined Patent Application Publication No. 2001-344152 is able to immediately judge the cache miss of the next index address which is obtained by adding one to the input index address

### SUMMARY

They cache memory disclosed in Japanese Unexamined Patent Application Publication No. 2001-344152 is able to concurrently execute hit judgment on an input address and a prefetch target address (hereinafter referred to as “prefetch address”). However, the only prefetch address that can be judged by the cache memory is the next index address that is obtained by adding one to the input index address. Such a configuration is effective when the memory access is performed in an address order. However, when the memory access is performed for the addresses that are not successive, the cache memory may not be able to effectively perform the prefetch In summary, although the cache memory disclosed in Japanese Unexamined Patent Application Publication No. 2001-344152 is able to execute the hit judgment for the input address and the prefetch address in parallel, as the prefetch target address is limited to the adjacent address, this technique lacks flexibility in address selection.

A first exemplary aspect of an embodiment of the present invention is a cache memory device including an address generation unit, a data memory, a tag memory, and a hit judging unit. The address generation unit generates a prefetch index address included in a prefetch address based on an input address supplied from a higher-level device. The data memory is able to store a part of data stored in a low-speed memory in a line unit. The tag memory is able to store a plurality of tag addresses corresponding to a plurality of line data stored in the data memory. The tag memory includes a memory component that is configured to receive the prefetch index address and an input index address included in the input address in parallel and to output a first tag address in accordance with the input index address and a second tag address in accordance with the prefetch index address in parallel. The hit judging unit performs cache hit judgment of the input address and the prefetch address based on the first tag address and the second tag address.

As described above, the cache memory device according to the first exemplary aspect of the present invention includes an address generation unit that generates the prefetch index address based on the input address, and the prefetch index address that is generated can be supplied to the tag memory. Further, the tag memory included in the cache memory device is able to concurrently receive the input index address and the prefetch index address, and to concurrently output the first and second tag addresses in accordance with the input index address and the prefetch index address.

The cache memory device according to the first aspect of the present invention is able to generate the prefetch address which is not limited to the adjacent address of the input address, and to concurrently execute the hit judgment for the input address and the prefetch address.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing the configuration of a cache memory according to an exemplary embodiment of the present invention;

FIG. 2 shows a configuration example of a tag memory included in the cache memory shown in FIG. 1;

FIG. 3 shows another configuration example of the tag memory included in the cache memory shown in FIG. 1;

FIG. 4 is a schematic diagram showing read processing of image data in a macro block unit;

FIG. 5 shows a configuration example of an address generation unit included in the cache memory shown in FIG. 1; and

FIG. 6 is a block diagram showing the configuration of a cache memory according to a related art.

### DETAILED DESCRIPTION OF THE EXEMPLARY EMBODIMENTS

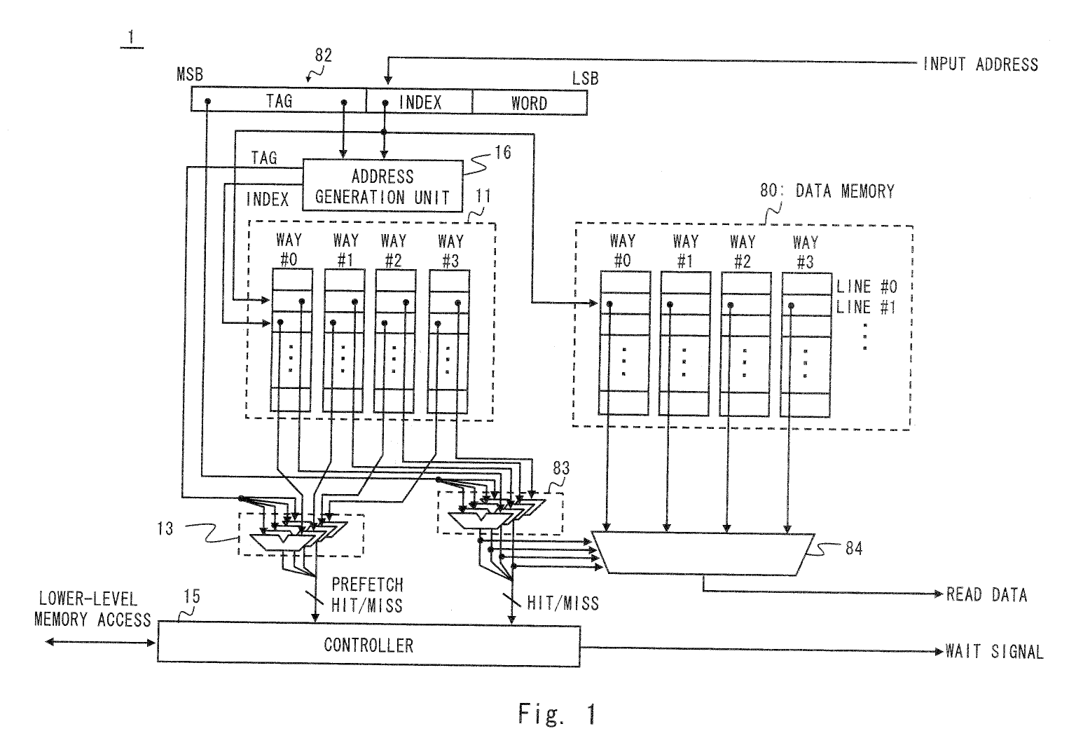

FIG. 1 is a block diagram showing the configuration of a cache memory 1 according to one exemplary embodiment of the present invention. A tag memory 11 included in the cache memory 1 includes a plurality of ways (four ways in the configuration example of FIG. 1). Further, each way of the tag memory 11 concurrently receives an input index address and a prefetch index address, and concurrently outputs two tag addresses that are held in two lines corresponding to the two index addresses.

Note that the tag address that is obtained by accessing the tag memory 11 with the input index address will be hereinafter called “first tag address” in order to discriminate the two tag addresses that are concurrently output from each way of the tag memory 11. On the other hand, the tag address that is obtained by accessing the tag memory 11 with the prefetch index address will be called “second tag address”.

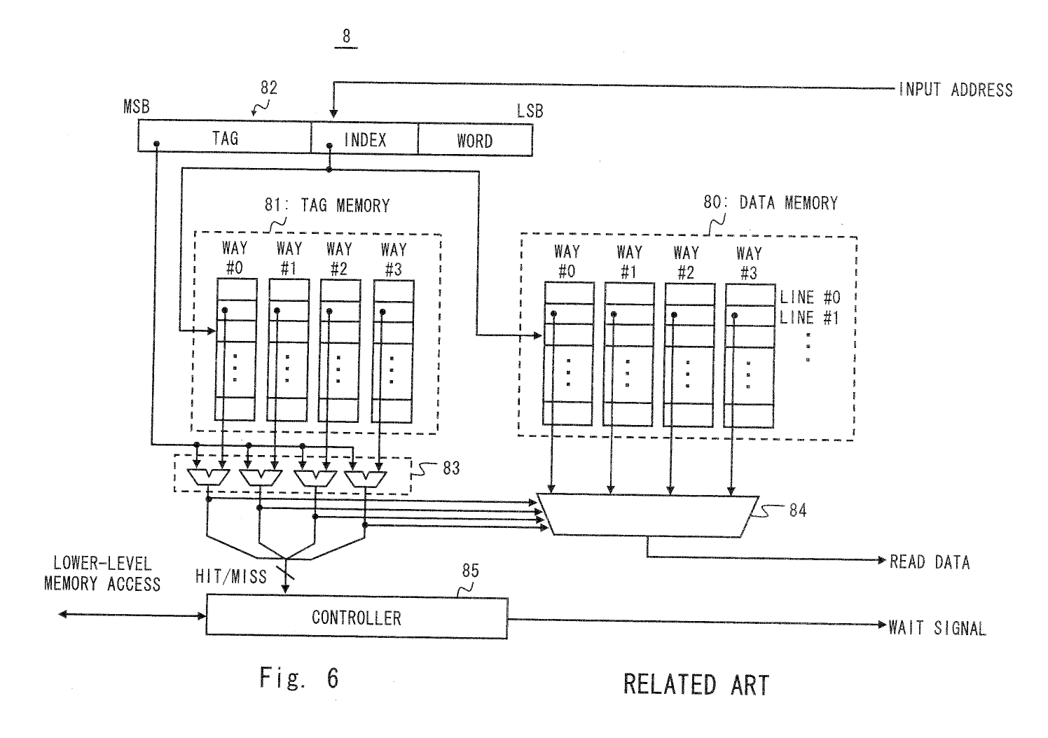

The four first tag addresses output from the four ways of the tag memory 11 are supplied to a hit judging unit 83. As stated above in the description of FIG. 6, the hit judging unit 83 compares the first tag address with the input tag address to perform hit judgment of the input address.

On the other hand, the four second tag addresses that are output from the four ways of the tag memory 11 are supplied to a hit judging unit 13. The hit judging unit 13 may be formed similarly to the hit judging unit 83. The hit judging unit 13 compares the second tag address with the prefetch tag address to perform hit judgment of the input address. The prefetch tag address is generated by an address generation unit 16 described below. Incidentally, there may be a case in which the prefetch tag address is equal to the input tag address due to the reason that the prefetch address is close to the input address. In such a case, the address generation unit 16 may not generate the prefetch tag address. In summary, the input tag address may be directly supplied to the hit judging unit 13 as the prefetch tag address. The judging result by the hit judging unit 13 is supplied to a controller 15 that will be described below.

The controller 15 controls rewriting of the tag memory 11 by the input tag address and refill of the data memory 80 when the hit judging unit 83 judges the cache miss of the input address, as is similar to the controller 85 described above. Further, the controller controls rewriting of the tag memory 11 by the prefetch tag address and refill of the data memory 80 when the hit judging unit 13 judges the cache miss of the prefetch address.

The address generation unit 16 generates the prefetch index address and the prefetch tag address based on the input address. The prefetch index address generated by the address generation unit 16 is supplied to the tag memory 11. The prefetch tag address that is generated by the address generation unit 16 is supplied to the hit judging unit 13. As described above, when the prefetch tag address is equal to the input tag address due to the reason that the prefetch address and the input address are close to each other, the address generation unit 16 may not generate the prefetch tag address

Needless to say, the entire configuration of the cache memory 1 shown in FIG. 1 is merely one example. For example, in order to reduce power consumption of the cache memory 1, a known entire configuration in which the data reading from the data memory 80 is performed only when the cache hit occurs, or a known entire configuration in which the data reading is performed by accessing the way that is hit may be employed instead of reading out the data from all the ways in the data memory 80. In this case, the controller 15 may output a chip select signal (CS signal) and a read strobe signal (RS signal) to the data memory 80 upon judgment of the cache hit by the hit judging unit 83, for example, so as to control the data reading from the data memory 80.

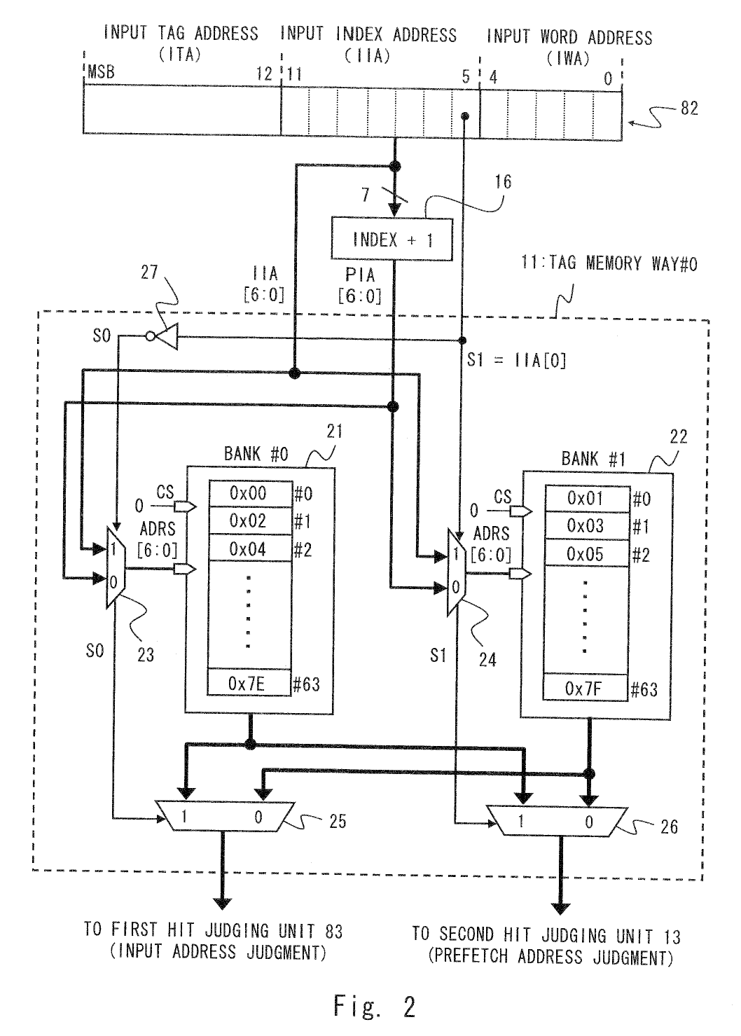

Hereinafter, the specific configuration example of the tag memory 11 will be described. FIG. 2 shows a configuration example of a way #0 included in the tag memory 11. Other ways may be formed similarly to the way #0.

In the example of FIG. 2, the address generation unit 16 generates an adjacent address which is obtained by adding one to the input index address (IIA) as the prefetch index address (PIA). When the prefetch index address is generated in accordance with such an an address generation rule, if one of the input index address and the prefetch index address is an even number, the other one is an odd number. Accordingly, in order to deal with the simultaneous parallel access by the input index address and the prefetch index address, each way of the tag memory 11 may be formed of a memory that includes two SRAM (Static Random Access Memory) banks 21 and 22. Then, an interleave arrangement may be employed in which the index address of the even number and the index address of the odd number are allocated to different banks.

In the specific example of FIG. 2, the length of the index address is seven bits, which means that the total number of lines of the tag memory 11 is 128. Among them, data for 64 lines of the index address of the even number are assigned to the SRAM bank 21. Then, data for 64 lines of the index address of the odd number are assigned to the SRAM bank 22.

A selector 23 selectively supplies the input index address (IIA) or the prefetch index address (PIA) to the address port of the SRAM bank 21. A selector 24 selectively supplies IIA or PIA to the address port of the SRAM bank 22. The selectors 23 and 24 operate complementary to each other. In other words, when one of the selectors 23 and 24 outputs IIA, the other one outputs PIA. A lowest bit IIA[0] of the input index address may be used as control signals S0 and S1 for determining the selection logic of the selectors 23 and 24. In the example of FIG. 2, IIA[0] is supplied to the selector 24 as the control signal S1, and a signal obtained by bit-inverting IIA[0] by an inverter 27 is supplied to the selector 23 as the control signal S0.

A selector 25 selects the first tag address supplied to the hit judging unit 83 that performs cache hit judgment of the input address from among the outputs of the SRAM banks 21 and 22. A selector 26 selects the second tag address that is supplied to the hit judging unit 13 that performs cache hit judgment of the prefetch address from among the outputs of the SRAM banks 21 and 22. The selectors 25 and 26 operate complementary to each other. In other words, when one of the selectors 25 and 26 selects the output of the SRAM bank 21, the other one selects the output of the SRAM bank 22. The lowest bit IIA[0] of the input index address may also be used as the control signals for determining the selection logic of the selectors 25 and 26, as is similar to the selectors 23 and 24.

In FIG. 2, the chip select (CS) terminals of the two SRAM banks 21 and 22 are always made active. However, when the target address range that is cached in the cache memory 1 is limited, a decoding circuit may further be provided. The decoding circuit judges whether IIA and PIA are cache target addresses and controls the CS terminals of the two SRAM banks 21 and 22 according to the judging result.

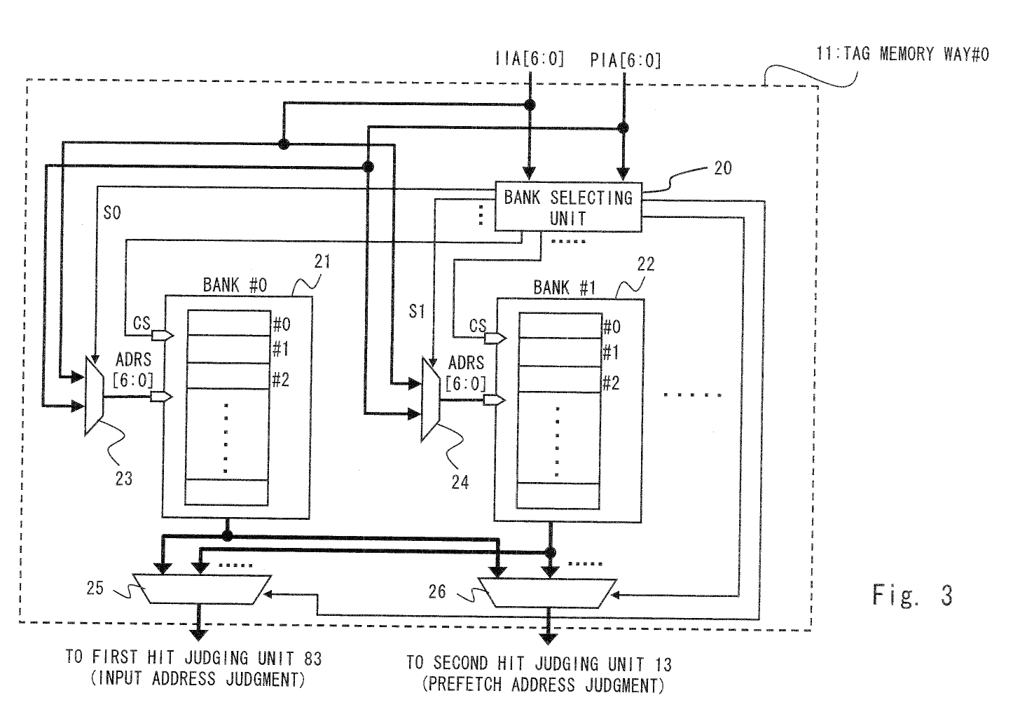

FIG. 3 shows another configuration example of the way #0 included in the tag memory 11. The configuration example of FIG. 3 may be generally applied when the number of SRAM banks is three or more. A bank selecting unit 20 decodes the input index address (IIA) and the prefetch index address (PIA) in order to select two SRAM banks that are sources of the first and second tag addresses. For example, when the total number of SRAM banks is two to the k-th power, the bank selecting unit 20 may decode lower k bits of IIA and PIA and make the CS terminals of the corresponding two SRAM banks active.

Further, the bank selecting unit 20 controls the selector group including the selectors 23 and 24 so that IIA is supplied to the address terminal of the SRAM bank which is the source of the first tag address and PIA is supplied to the address terminal of the SRAM bank which is the source of the second tag address. Further, the bank selecting unit 20 controls the selectors 25 and 26 to select the tag addresses that are supplied to the hit judging units 83 and 13.

Note that, as is stated regarding FIG. 2, there is also a case in which the target address range that is cached in the cache memory 1 is limited. In such a case, the bank selecting unit 20 may judge whether IIA and PIA are cache target addresses to control the CS terminal of each SRAM bank according to the judging result.

By the way, the memory component that can be used in each way of the tag memory 11 is not limited to a multiport memory having a bank configuration as shown in FIGS. 2 and 3. A memory component in which a plurality of sets of word lines and bit lines (Q and QB) are connected to each memory cell of the SRAM, which is the memory component having a plurality of inputs and outputs in a memory cell unit may be used for each way of the tag memory 11.

Hereinafter, the configuration example of the address generation unit 16 will be described. In order to describe the specific example in which the prefetch index address is not limited to the next address of the input index address, description will be made of an example in which the image data is read out in a macro block unit. In a codec technique such as JPEG, MPEG2, and MPEG4, image processing such as discrete cosine transform or the like is performed in a unit of square image block such as four horizontal*four vertical pixels, or eight horizontal*eight vertical pixels. Such a square image block is called macro block.

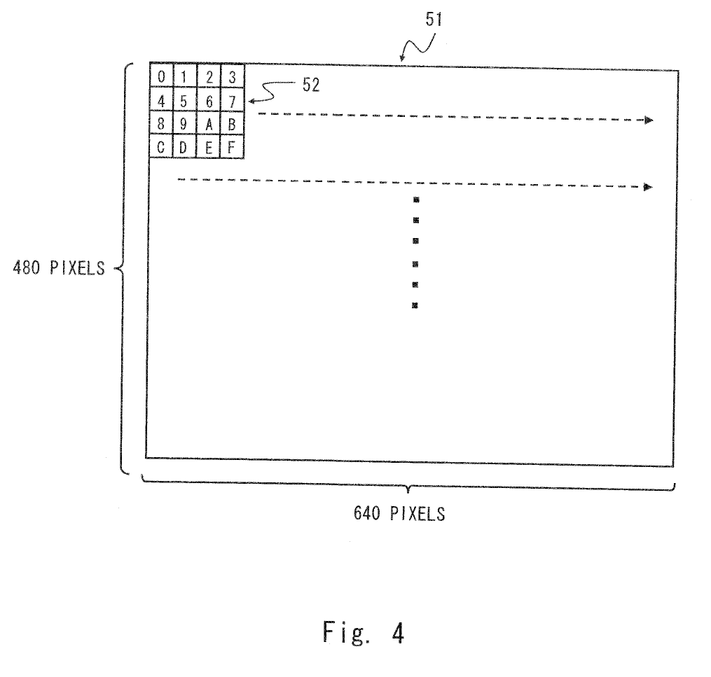

FIG. 4 shows an image frame 51 of 640 horizontal*480 vertical pixels, and a macro block 52 of four horizontal*four vertical pixels. In order to perform prefetch in accordance with the data reading in the macro block unit, for example, it is preferable to set address of the top pixel (pixel No. 4) of the second row of the macro block 52 as the prefetch address when the input address corresponds to the last pixel (pixel No. 3) of the first row of the macro block 52.

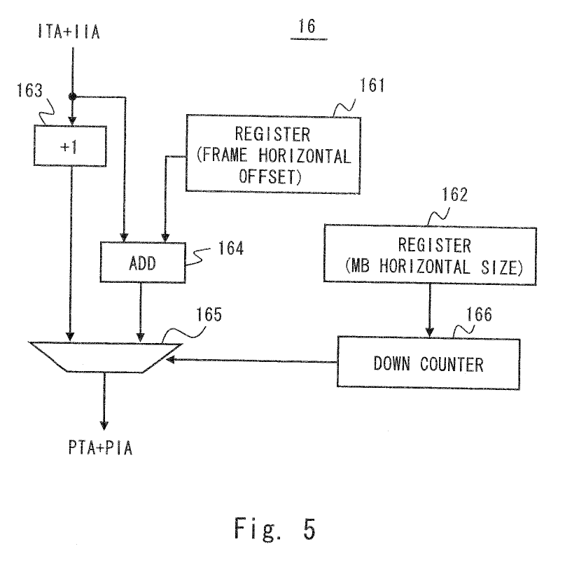

FIG. 5 is a block diagram showing a configuration example of the address generation unit 16 that is able to generate the prefetch address in accordance with the data reading in the macro block unit. Note that, for the purpose of simplicity, it is assumed that the data size for each one pixel of the image frame 51 is equal to the line width of the data memory 80 (data size for each one line).

When the input address is the last pixel of any one of a total of m rows in the macro block 52, the address generation unit 16 in FIG. 5 sets the address that indicates the top pixel of the next row in the macro block 52 as the prefetch address. Further, when the input address is not the last pixel of any one of the rows in the macro block 52, the address generation unit 16 in FIG. 5 sets the address obtained by increasing the input address by one pixel to the prefetch address. Hereinafter, each component shown in FIG. 5 will be described in detail.

The register 161 is the one that holds the offset value in accordance with the horizontal size of the image frame 51. More specifically, the register 161 may hold a value obtained by subtracting the total number of horizontal pixels of the macro block 52 (four pixels) from the total number of horizontal pixels of the image frame 51 (640 pixels), and thereafter adding one to this value (637 pixels).

A register 162 holds a value in accordance with the horizontal size of the macro block 52. More specifically, the register 162 may hold a value (three) that is obtained by subtracting one from the total number of horizontal pixels of the macro block 52 (four pixels) The value of the register 162 will be the initial value of a down counter 166.

The down counter 166 subtracts one from the value held in itself in synchronization with the generation cycle of the prefetch address.

An adder 163 receives the input tag address (ITA) and the input index address (IIA), and outputs the address obtained by adding one to it.

An adder 164 receives the input tag address (ITA) and the input index address (IIA), and adds this value and the value of the register 161.

A selector 165 selects the output address of any one of the adders 163 and 164, and outputs the selected address as the prefetch tag address (PTA) and the prefetch index address (PIA). The selecting operation of the selector 165 is performed by the value of the down counter 166. As stated above, if the value obtained by subtracting one from the total number of horizontal pixels of the macro block 52 is the initial value of the down counter 166, when the value of the down counter 166 is not zero, the selector 165 selects the output of the adder 163. On the other hand, when the value of the down counter 166 is zero, the selector 165 selects the output of the adder 164.

Further, in order to deal with the sequential reading of the image data in the macro block unit, when the input address is the last pixel (pixel No. F) of the macro block 52, the prefetch address will be set to the top pixel (pixel No. 1) of the next macro block.

Further, in order to improve reliability of the prefetch corresponding to the reading of the image data in the macro block unit, the number of SRAM banks of each way of the tag memory 11 may be set to a value equal to or more than the number of horizontal pixels of the macro block. In accordance with this, an interleaved arrangement may be employed in which the successive index addresses are allocated to different SRAM banks. Accordingly, the access conflict to the same bank by the input address and the prefetch address can be absolutely prevented.

As described above, in the address generation unit 16 included in the cache memory 1 according to the exemplary embodiment of the present invention, the prefetch address which is not limited to the adjacent address of the input address can be generated in accordance with the predetermined address generation rule, for example, the address generation rule in accordance with the reading of the image data in the macro block unit. Further, the tag memory 11 is able to receive the input index address and the prefetch index address in parallel and to output the first and second tag addresses in parallel. In short, the cache memory 1 is able to generate the prefetch address which is not limited to the adjacent address of the input address and at the same time, to perform the hit judgment for the input address and the prefetch address in parallel. Furthermore, as the hit judgment of the input address and the prefetch address can be performed in parallel, the access to the lower-level memory can be performed in high speed and with high efficiency.

Although the set associative cache memory has been shown in the exemplary embodiment described above, the present invention can also be applied to a direct map cache memory which has one way.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A cache memory device disposed between a higher-level device and a low-speed memory, comprising:
an address generation unit that generates a prefetch index address included in a prefetch address based on an input address supplied from the higher-level device;
a data memory that is able to store a part of data stored in the low-speed memory in a line unit;
a tag memory that is able to store a plurality of tag addresses corresponding to a plurality of line data stored in the data memory, the tag memory comprising a memory component that is configured to receive the prefetch index address and an input index address included in the input address in parallel and to output a first tag address in accordance with the input index address and a second tag address in accordance with the prefetch index address in parallel; and
a hit judging unit that performs cache hit judgment of the input address and the prefetch address based on the first tag address and the second tag address.

2. The cache memory device according to claim 1, wherein the hit judging unit comprises:
a first hit judging unit that judges a cache hit of the input address by comparing the first tag address with an input tag address included in the input address; and
a second hit judging unit that judges a cache hit of the prefetch address by comparing the second tag address with a prefetch tag address included in the prefetch address in parallel with a cache hit judgment by the first hit judging unit.

3. The cache memory device according to claim 2, wherein the address generation unit generates the prefetch tag address in addition to the prefetch index address, and is configured to supply the prefetch index address to the tag memory and the prefetch tag address to the second hit judging unit.

4. The cache memory device according to claim 1, wherein the memory component comprises:
a plurality of SRAM (static random access memory) banks; and
a selection unit that selects one of the plurality of SRAM banks as an output source of the first tag address and selects another one of the plurality of SRAM banks as an output source of the second tag address.

5. The cache memory device according to claim 4, wherein
the number of the plurality of SRAM banks is 2 to the k-th power, and
the selection unit is configured to select the output source of the first tag address by decoding lower k bits of the input index address, and is configured to select the output source of the second tag address by decoding lower k bits of the prefetch index address.

6. The cache memory device according to claim 1 wherein the address generation unit is configured to generate the prefetch index address based on an address generation rule in accordance with the access to read out an image data of N horizontal pixels and M vertical pixels that is stored in the low-speed memory in a rectangular image block unit of n horizontal pixels (n<N, n<M) and m vertical pixels (m<N, m<M).

7. The cache memory device according to claim 6, wherein
when the input address is a last pixel of any one of a total of m rows in a first rectangular pixel block included in the image data, the address generating unit is configured to set an address showing a top pixel in a next row in the first rectangular pixel block or a top pixel in a top row of a second rectangular pixel block that is accessed next to the first rectangular pixel block as the prefetch address, and
when the input address is not the last pixel, the address generating unit is configured to set an address obtained by increasing the input address by one pixel as the prefetch address.
